(19) United States
(12) Patent Application Publication
(10) Pub. No.: US 2011/0141883 A1
(43) Pub. Date: Jun. 16, 2011

(54) MULTI-LANE CONTROL APPARATUS AND METHOD USING CONTROL SIGNAL OF PHYSICAL LAYER

(75) Inventor: Yongtae KIM, Daejeon (KR)

(73) Assignee: Electronics and Telecommunications Research Institute, Daejeon (KR)

(21) Appl. No.: 12/851,179

(22) Filed: Aug. 5, 2010

(30) Foreign Application Priority Data
Dec. 16, 2009 (KR) 10-2009-0125331
Feb. 23, 2010 (KR) 10-2010-0016245

(51) Int. Cl. H04L 12/26

(52) U.S. Cl. 370/225

(57) ABSTRACT

A multi-lane control apparatus and method using a control signal of a physical layer are provided. The multi-lane control apparatus includes a detector to detect a fault in a first transmission lane of a reciprocal module and to generate a loss signal of a first reception lane that is physically connected to the first transmission lane, and a controller to turn off a second transmission lane corresponding to the first reception lane in response to the loss signal.

### CROSS-REFERENCE TO RELATED APPLICATIONS

This application claims the benefit of Korean Patent Application No. 10-2009-0125331 and of Korean Patent Application No. 10-2010-0016245, respectively filed on Dec. 16, 2009 and Feb. 23, 2010, in the Korean Intellectual Property Office, the disclosures of which are incorporated herein by reference.

### BACKGROUND

1. Field of the Invention

The present invention relates to a multi-lane control module apparatus and method using a control signal of a physical layer that may minimize a power consumption by controlling a power of a lane where a fault occurs among multiple lanes.

2. Description of the Related Art

As a number of apparatuses connected to a network increases and a higher data transmission rate is required, there is a desire for a new transmission scheme for transmitting data at a high rate. In an Ethernet apparatus, to overcome limitations in speed where a bandwidth is increased, a bandwidth is generally extended using multiple lanes. Here, the Ethernet apparatus may employ the multiple lanes to reduce burdens on processing of high-speed signals and development of components. However, since a large number of components are used to constitute multiple lanes, hardware faults or errors may occur. In particular, a Physical Media Attachment (PMA) and a Physical Media Dependent (PMD) that are configured with multiple lanes are susceptible the faults or errors, unlike a Media Access Control (MAC) and a Physical Coding Sublayer (PCS) that are configured with a single chip.

### SUMMARY

An aspect of the present invention provides a multi-lane control apparatus and method that may minimize a power consumption by controlling a power of a reception lane connected to a transmission lane of a reciprocal module or a power of a transmission lane corresponding to the reception lane, when a fault occurs in the transmission lane of the reciprocal module.

According to an aspect of the present invention, there is provided a multi-lane control apparatus using a control signal of a physical layer, the multi-lane control apparatus including a detector to detect a fault in a first transmission lane of a reciprocal module and to generate a loss signal of a first reception lane, the first reception lane being physically connected to the first transmission lane, and a controller to turn a second transmission lane off in response to the loss signal, the second transmission lane corresponding to the first reception lane.

According to another aspect of the present invention, there is provided a multi-lane control apparatus using a control signal of a physical layer, the multi-lane control apparatus including a flag generator to generate a fault flag with a set value when a fault occurs in a first transmission lane, a detector to detect an off state of a second transmission lane of a reciprocal module and to generate a loss signal of a second reception lane, the second transmission lane of the reciprocal module corresponding to a first reception lane of the reciprocal module, the first reception lane being physically connected to the first transmission lane, and the second reception lane being physically connected to the second transmission lane, and a controller to turn the first transmission lane off in response to the loss signal, the first transmission lane corresponding to the second reception lane.

According to another aspect of the present invention, there is provided a multi-lane control method including detecting a fault in a first transmission lane of a reciprocal module and generating a loss signal of a first reception lane, the first reception lane being physically connected to the first transmission lane, and turning a second transmission lane off in response to the loss signal, the second transmission lane corresponding to the first reception lane.

According to another aspect of the present invention, there is provided a multi-lane control method including generating a fault flag with a set value when a fault occurs in a first transmission lane, detecting an off state of a second transmission lane of a reciprocal module and generating a loss signal of a second reception lane, the second transmission lane of the reciprocal module corresponding to a first reception lane of the reciprocal module, the first reception lane being physically connected to the first transmission lane, and the second reception lane being physically connected to the second transmission lane, and turning the first transmission lane off in response to the loss signal, the first transmission lane corresponding to the second reception lane.

### EFFECT

According to embodiments of the present invention, it is possible to minimize a power consumption by controlling a power of a reception lane connected to a transmission lane of a reciprocal module or a power of a transmission lane corresponding to the reception lane, when a fault occurs in the transmission lane of the reciprocal module.

Accordingly, it is possible to easily control operations for each lane by controlling a power of a lane upon an occurrence of a fault of the lane, and it is possible to improve stability of an apparatus.

Additionally, according to embodiments of the present invention, a module may be controlled and communicated in an upper layer and thus, it is possible to determine a state of a lane using an optical signal of a Physical Media Dependent (PMD), unlike a conventional multi-lane control method where an upper layer of a reciprocal module matched with the module and a dedicated communication channel are generated and managed. Thus, it is possible to reduce complexity of generation and management of a separate communication channel.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a high-speed Ethernet to which a multi-lane control apparatus using a control signal of a physical layer is applied, according to an embodiment of the present invention;

FIG. 2 is a block diagram illustrating a configuration of a multi-lane control system using a control signal of a physical layer according to an embodiment of the present invention;

FIG. 3 is a block diagram illustrating a configuration of a multi-lane control system using a control signal of a physical layer according to another embodiment of the present invention;

FIG. 4 is a diagram illustrating an example of an assignment of a hardware pin of a Centum Form-factor Pluggable (CFP) Multi-Source Agreement (MSA) corresponding to a Physical Media Dependent (PMD) used to transfer control information in response to a detected loss signal, in a multi-lane control system using a control signal of a physical layer according to an embodiment of the present invention;

FIG. 5 is a flowchart illustrating a multi-lane control method using a control signal of a physical layer according to an embodiment of the present invention; and

FIG. 6 is a flowchart illustrating a multi-lane control method using a control signal of a physical layer according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

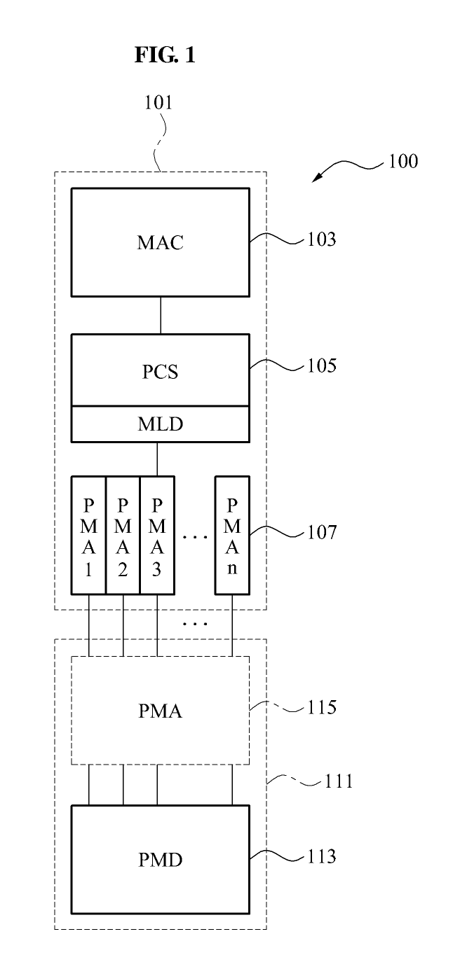

FIG. 1 illustrates a configuration of a high-speed Ethernet 100 to which a multi-lane control apparatus using a control signal of a physical layer is applied, according to an embodiment of the present invention.

Referring to FIG. 1, the high-speed Ethernet 100 includes a first module 101, and a second module 111.

The first module 101 includes a Media Access Control (MAC) 103, a Physical Coding Sublayer (PCS) 105, and a plurality of Physical Media Attachments (PMAs) 107. The first module 101 may be physically or logically matched with the second module 111 through multiple lanes.

The second module 111 includes a Physical Media Dependent (PMD) 113, and may selectively include a PMA 115.

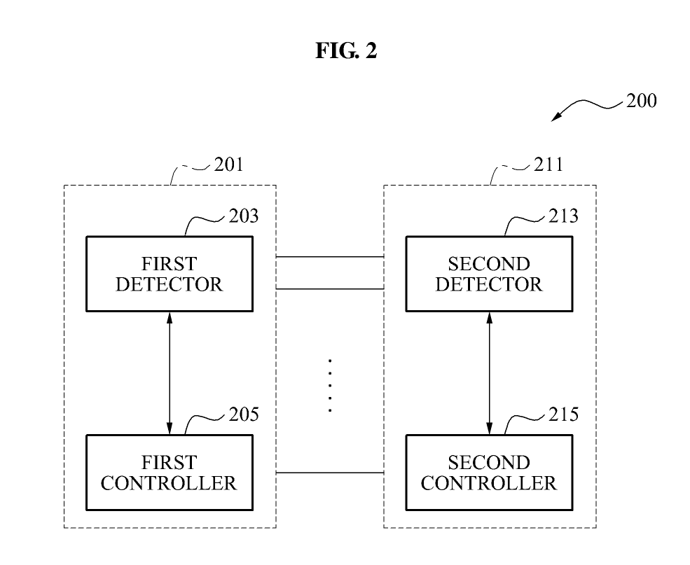

FIG. 2 illustrates a configuration of a multi-lane control system 200 using a control signal of a physical layer according to an embodiment of the present invention.

Referring to FIG. 2, the multi-lane control system 200 includes a first multi-lane control module 201, and a second multi-lane control module 211.

The first multi-lane control module 201 includes a first detector 203, and a first controller 205.

The first detector 203 may detect a fault in a first transmission lane of a reciprocal module, namely, the second multi-lane control module 211, and may generate a loss signal of a first reception lane. Here, the first reception lane may be physically connected to the first transmission lane. Additionally, the first detector 203 may be implemented by a receiver RX that is used to control the first reception lane.

When an off state of the first transmission lane is detected, the first detector 203 may generate the loss signal of the first reception lane.

The first controller 205 may turn a second transmission lane off in response to the loss signal. Here, the second transmission lane may correspond to the first reception lane. Additionally, the first controller 205 may power off a transmitter TX that is used to control the second transmission lane, so that the second transmission lane may be turned off.

The first controller 205 may turn the first reception lane off in response to the loss signal of the first reception lane.

The second multi-lane control module 211 includes a second detector 213, and a second controller 215.

The second detector 213 may detect a fault in a second transmission lane of a reciprocal module, namely, the first multi-lane control module 201, and may generate a loss signal of a second reception lane. Here, the second reception lane may be physically connected to the second transmission lane. Additionally, the second detector 213 may be implemented by a receiver RX that is used to control the second reception lane.

When an off state of the second transmission lane is detected, the second detector 213 may generate the loss signal of the second reception lane.

The second controller 215 may turn a first transmission lane off in response to the loss signal. Here, the first transmission lane may correspond to the second reception lane. Additionally, the second controller 215 may power off a transmitter TX that is used to control the first transmission lane, so that the first transmission lane may be turned off.

The second controller 215 may turn the second reception lane off in response to the loss signal of the second reception lane.

When a fault occurs in a first transmission lane of a second multi-lane control module, a multi-lane control system according to an embodiment of the present invention may minimize a power consumption by turning off at least one of a first reception lane of a first multi-lane control module that is physically connected to the first transmission lane, a second transmission lane corresponding to the first reception lane, a second reception lane of the second multi-lane control module that is physically connected to the second transmission lane, and a first transmission lane corresponding to the second reception lane.

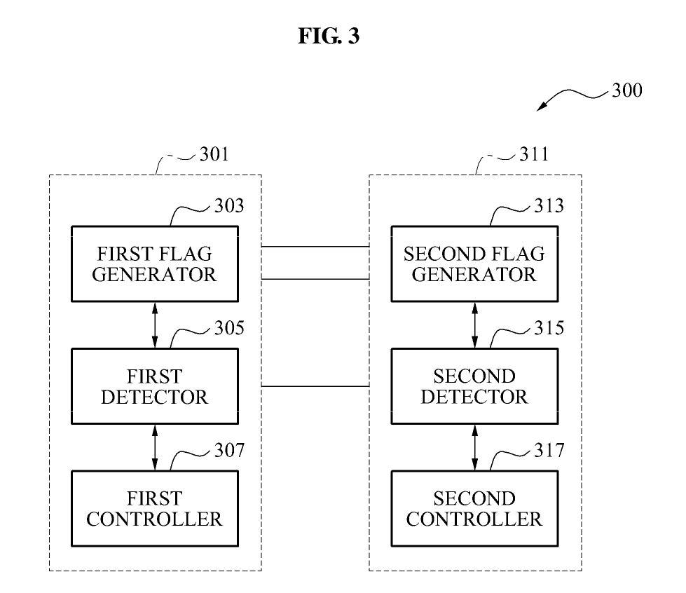

FIG. 3 illustrates a configuration of a multi-lane control system 300 using a control signal of a physical layer according to another embodiment of the present invention.

Referring to FIG. 3, the multi-lane control system 300 includes a first multi-lane control module 301, and a second multi-lane control module 311.

The first multi-lane control module 301 includes a first flag generator 303, a first detector 305, and a first controller 307.

The first flag generator 303 may generate a fault flag with a set value when a fault occurs in a first transmission lane of the first multi-lane control module 301. For example, a value of the generated fault flag may be set to be “1.”

The first detector 305 may detect an off state of a second transmission lane of a reciprocal module, namely the second multi-lane control module 311, and may generate a loss signal of a second reception lane that is physically connected to the second transmission lane. Here, the second transmission lane of the second multi-lane control module 311 may correspond to a first reception lane of the second multi-lane control module 311, and the first reception lane may be physically connected to the first transmission lane.

Additionally, when a fault in the second transmission lane of the second multi-lane control module 311 is detected, the first detector 305 may generate the loss signal of the second reception lane.

The first controller 307 may turn the first transmission lane off in response to the loss signal of the second reception lane. Here, the first transmission lane may correspond to the second reception lane.

Additionally, the first controller 307 may control the second reception lane to be on or off based on a value of the fault flag. Specifically, when the fault flag has the set value, the first controller 307 may turn the second reception lane off. Also, when the fault flag has a value different from the set value, the first controller 307 may maintain an on state of the second reception lane. For example, when the fault flag has a value of “1”, the first controller 307 may turn the second reception lane off. Also, when the fault flag has a value different from “1”, the first controller 307 may maintain an on state of the second reception lane.

The second multi-lane control module 311 includes a second flag generator 313, a second detector 315, and a second controller 317.

The second flag generator 313 may generate a fault flag with a set value when a fault occurs in a second transmission lane of the second multi-lane control module 311. For example, a value of the generated fault flag may be set to be “1” in the same manner as the first flag generator 303.

The second detector 315 may detect an off state of the first transmission lane of the reciprocal module, namely the first multi-lane control module 301, and may generate a loss signal of a first reception lane that is physically connected to the first transmission lane. Here, the first transmission lane of the first multi-lane control module 301 may correspond to a second reception lane of the first multi-lane control module 301, and the second reception lane may be physically connected to the second transmission lane.

Additionally, when a fault in the first transmission lane of the first multi-lane control module 301 is detected, the second detector 315 may generate the loss signal of the first reception lane.

The second controller 317 may turn the second transmission lane off, in response to the loss signal of the first reception lane. Here, the second transmission lane may correspond to the first reception lane.

Additionally, the second controller 317 may control the first reception lane to be on or off based on a value of the fault flag. Specifically, when the fault flag has the set value, the second controller 317 may turn the first reception lane off. Also, when the fault flag has a value different from the set value, the second controller 317 may maintain an on state of the first reception lane. For example, when the fault flag has a value of “1”, the second controller 317 may turn the first reception lane off. Also, when the fault flag has a value different from “1”, the second controller 317 may maintain an on state of the first reception lane.

When a fault occurs in a first transmission lane of a first multi-lane control module, a multi-lane control system according to an embodiment of the present invention may minimize a power consumption by turning off at least one of a second transmission lane corresponding to a first reception lane of a second multi-lane control module that is physically connected to the first transmission lane, a second reception lane of the first multi-lane control module that is physically connected to the second transmission lane, and a first transmission lane corresponding to the second reception lane, by maintaining an on state of the first reception lane of the second multi-lane control module where no fault occurs, and by activating the first reception lane corresponding to a communication channel.

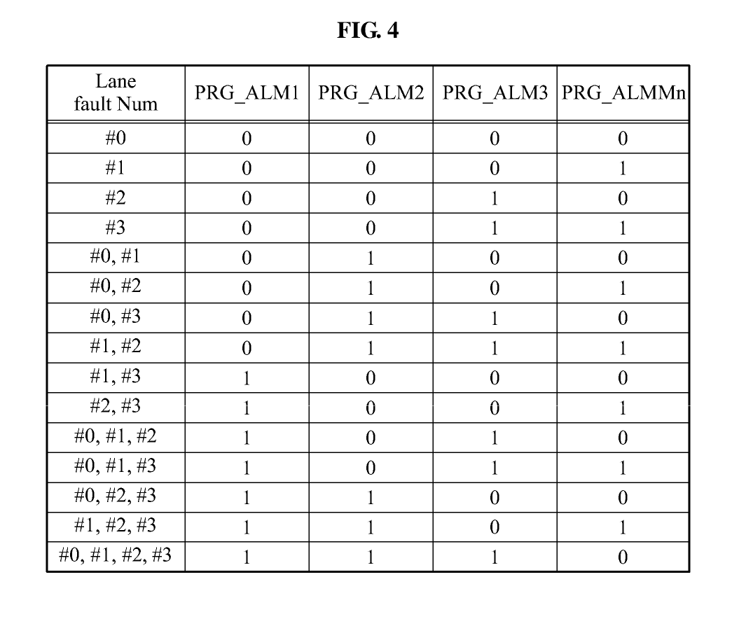

FIG. 4 illustrates an example of an assignment of a hardware pin of a Centum Form-factor Pluggable (CFP) Multi-Source Agreement (MSA) corresponding to a PMD used to transfer control information in response to a detected loss signal, in a multi-lane control system using a control signal of a physical layer according to an embodiment of the present invention.

Referring to FIG. 4, the multi-lane control system may assign unique information to each pin based on a number of a lane where a fault occurred among four lanes.

In the multi-lane control system, when a controller is implemented in a processor in the PMD, the controller may easily combine information using a local bus provided by the processor or a General Purpose Input Output (GPIO). However, when a controller exists in an upper processor, the controller may combine information through a Management Data Clock/Management Data Input Output (MDC/MDIO) bus. Here, since the MDC/MDIO bus is a low-speed serial bus, use of the MDC/MDIO bus may be inappropriate for a control method of a high-speed Ethernet. Accordingly, the controller may desirably use the hardware pin of the PMD, to control a lane having a rapid response rate. In other words, the controller may acquire control information using reserved pins of the PMD or using a combination of pins that are defined in advance.

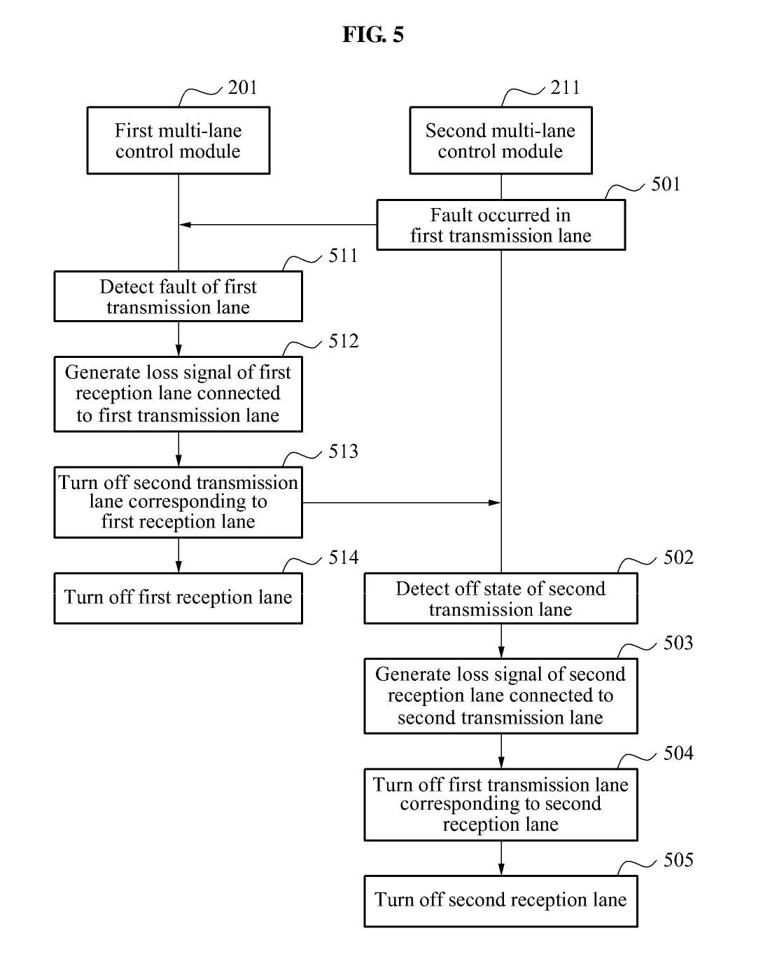

FIG. 5 is a flowchart illustrating a multi-lane control method using a control signal of a physical layer according to an embodiment of the present invention.

Referring to FIG. 5, when a fault occurs in a first transmission lane of a reciprocal module, namely a second multi-lane control module 211 in operation 501, a first multi-lane control module 201 may detect the fault of the first transmission lane through a first reception lane of the first multi-lane control module 201 in operation 511. Here, the first reception lane of the first multi-lane control module 201 may be physically connected to the first transmission lane of the second multi-lane control module 211.

The first multi-lane control module 201 may generate a loss signal of the first reception lane in operation 512, and may turn off a second transmission lane of the first multi-lane control module 201 that corresponds to the first reception lane, in operation 513. Additionally, the first multi-lane control module 201 may turn off the first reception lane in response to the loss signal of the first reception lane in operation 514.

When the second transmission lane of the first multi-lane control module 201 is turned off, the second multi-lane control module 211 may detect an off state of the second transmission lane through a second reception lane of the second multi-lane control module 211 in operation 502. Here, the second reception lane of the second multi-lane control module 211 may be physically connected to the second transmission lane of the first multi-lane control module 201.

The second multi-lane control module 211 may generate a loss signal of the second reception lane of the second multi-lane control module 211 in operation 503, and may turn off the first transmission lane of the second multi-lane control module 211 that corresponds to the second reception lane, in operation 504. Additionally, the second multi-lane control module 211 may turn off the second reception lane in response to the loss signal of the second reception lane in operation 505.

While the multi-lane control method according to the embodiment of the present invention has been described under the assumption that the fault occurs in the first transmission lane of the second multi-lane control module 211, the assumption is merely for ease of description and there is no limitation thereto. Accordingly, the multi-lane control method according to the embodiment of the present invention may also be applied to an example in which a fault occurs in the second transmission lane of the first multi-lane control module 201.

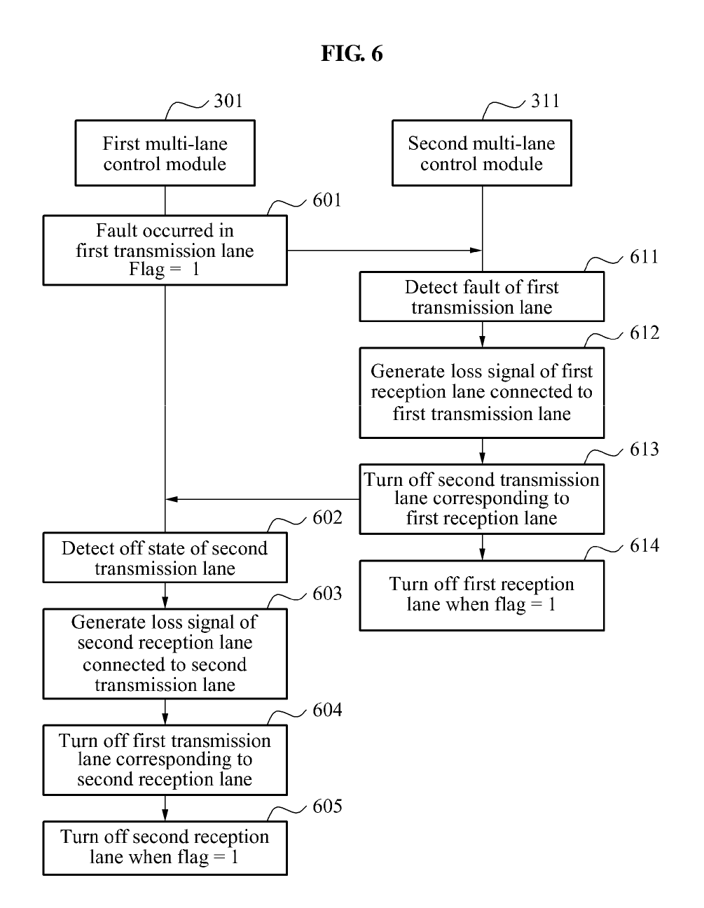

FIG. 6 is a flowchart illustrating a multi-lane control method using a control signal of a physical layer according to another embodiment of the present invention.

Referring to FIG. 6, when a fault occurs in a first transmission lane of a first multi-lane control module 301, the first multi-lane control module 301 may generate a fault flag with a set value in operation 601. For example, a value of the generated fault flag may be set to be “1.”

When the fault occurs in the first transmission lane of the first multi-lane control module 301, a reciprocal module, namely a second multi-lane control module 311, may detect the fault of the first transmission lane through a first reception lane of the second multi-lane control module 311 in operation 611. Here, the first reception lane of the second multi-lane control module 311 may be physically connected to the first transmission lane of the first multi-lane control module 301.

The second multi-lane control module 311 may generate a loss signal of the first reception lane of the second multi-lane control module 311 in operation 612, and may turn off a second transmission lane of the second multi-lane control module 311 that corresponds to the first reception lane in operation 613. Additionally, when a flag is set to be “1” in response to the loss signal of the first reception lane, the second multi-lane control module 311 may turn off the first reception lane in operation 614. As a result, when a fault does not occur in the second transmission lane of the second multi-lane control module 311, that is, when a flag is set to be a value different from “1,” the second multi-lane control module 311 may maintain an on state of the first reception lane.

When the second transmission lane of the second multi-lane control module 311 is turned off, the first multi-lane control module 301 may detect an off state of the second transmission lane, through a second reception lane of the first multi-lane control module 301 in operation 602. Here, the second reception lane of the first multi-lane control module 301 may be physically connected to the second transmission lane.

The first multi-lane control module 301 may generate a loss signal of the second reception lane of the first multi-lane control module 301 in operation 603, and may turn off the first transmission lane of the first multi-lane control module 301 that corresponds to the second reception lane in operation 604. Additionally, when a flag is set to be “1” in response to the loss signal of the second reception lane, the first multi-lane control module 301 may turn off the second reception lane in operation 605. As a result, the flag may be set to be “1” upon an occurrence of the fault in the first transmission lane of the first multi-lane control module 301, and thus, the first multi-lane control module 301 may turn off the second reception lane.

The multi-lane control methods using a control signal of a physical layer according to the above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A multi-lane control apparatus using a control signal of a physical layer, the multi-lane control apparatus comprising:
a detector to detect a fault in a first transmission lane of a reciprocal module and to generate a loss signal of a first reception lane, the first reception lane being physically connected to the first transmission lane; and
a controller to turn a second transmission lane off in response to the loss signal, the second transmission lane corresponding to the first reception lane.

2. The multi-lane control apparatus of claim 1, wherein the detector detects an off state of the first transmission lane of the reciprocal module, and generates the loss signal of the first reception lane.

3. The multi-lane control apparatus of claim 1, wherein the controller turns the first reception lane off in response to the loss signal.

4. A multi-lane control apparatus using a control signal of a physical layer, the multi-lane control apparatus comprising:
a flag generator to generate a fault flag with a set value when a fault occurs in a first transmission lane;
a detector to detect an off state of a second transmission lane of a reciprocal module and to generate a loss signal of a second reception lane, the second transmission lane of the reciprocal module corresponding to a first reception lane of the reciprocal module, the first reception lane being physically connected to the first transmission lane, and the second reception lane being physically connected to the second transmission lane; and
a controller to turn the first transmission lane off in response to the loss signal, the first transmission lane corresponding to the second reception lane.

5. The multi-lane control apparatus of claim 4, wherein the detector detects a fault in the second transmission lane of the reciprocal module and generates the signal of the second reception lane.

6. The multi-lane control apparatus of claim 4, wherein, when the fault flag includes the set value, the controller turns the second reception lane off, and
when the fault flag includes a value different from the set value, the controller maintains an on state of the second reception lane.

7. A multi-lane control method, comprising:
detecting a fault in a first transmission lane of a reciprocal module and generating a loss signal of a first reception lane, the first reception lane being physically connected to the first transmission lane; and
turning a second transmission lane off in response to the loss signal, the second transmission lane corresponding to the first reception lane.

8. The multi-lane control method of claim 7, further comprising:
detecting an off state of the first transmission lane of the reciprocal module, and generating a loss signal of the first reception lane.

9. The multi-lane control method of claim 7, further comprising:
turning the first reception lane off in response to the loss signal.

10. The multi-lane control method of claim 7, further comprising:
generating a fault flag with a set value, when a fault occurs in the second transmission lane; and
detecting an off state of the first transmission lane of the reciprocal module, and generating a loss signal of the first reception lane, the first transmission lane of the reciprocal module corresponding to a second reception lane of the reciprocal module, the second reception lane being physically connected to the second transmission lane, and the first reception lane being physically connected to the first transmission lane.
